(19) United States
(12) Patent Application Publication
(10) Pub. No.: US 2007/0043791 A1
(43) Pub. Date: Feb. 22, 2007

(54) Data backup system

(75) Inventors: Nobuyuki Tada, Odawara (JP); Nobuaki Higashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/477,587

(22) Filed: Jun. 30, 2006

(30) Foreign Application Priority Data
Aug. 16, 2005 (JP) 2005-235877

(51) Int. Cl. G06F 17/30

(52) U.S. Cl. 707/204

(57) ABSTRACT

A data backup system which includes: a storage medium cartridge for storing target data; an auxiliary storage medium mounted on the storage medium cartridge; a data backup method for backing up the target data in the storage medium cartridge; and a history information writing method for writing backup history information containing at least information of updated date of the backup history information in the auxiliary storage medium with different means from the data backup method, wherein the history information writing method writes the backup history information in the auxiliary storage medium after the data backup method backs up the target data in the storage medium cartridge.

### CROSS REFERENCE TO RELATED APPLICATIONS

This application claims the foreign priority benefit under Title 35, United States Code, §119(a)-(d) of Japanese Patent Application No. 2005-235877, filed on Aug. 16, 2005, the contents of which are hereby incorporated by reference.

### BACKGROUND OF THE INVENTION

1. Field of the Invention

The present invention relates to a data backup system.

2. Description of Relevant Art

In a company, organization, and agency which handle a large quantity of data, or confidential important data such as personal information, the data is stored in a large capacity storage medium such as a magnetic tape cartridge as backup data for preventing the data from being lost. Specifically, a data backup operation is implemented as follows.

For example, for backing up data with a given period, a day of the week for fully backing up backup target data (hereinafter, referred to as target data) is determined, and the target data is fully backed up (full data backup) once a week. In addition, on a day other than the day of the full data backup, a difference of data from the preceding day is backed up (difference data backup). In this case, a magnetic tape cartridge for data backup specific to each day of the week is prepared, and data is overwritten on the data of the day of the preceding week. The backed up data can be checked by an operator with eyes on a display of a backup computer where backup software runs.

Meanwhile, a data backup system which simultaneously stores backup history information, when the data backup is implemented, such as information of date and time of backup data updating (backup date information) in the magnetic tape in which the target data is backed up has been disclosed in, for example, a paragraph [0090] of Japanese Laid-Open Patent Publication No. 10-027070.

However, the magnetic tape cartridge for data backup is kept at a distant place in general in preparation for disaster. Therefore, a data backup system in which the backup software runs, or a system identical to the data backup system is not always exists close to the magnetic tape cartridge for data backup. Because of this reason, an operator can not easily confirm contents of the target data (backup data) stored in each magnetic tape cartridge whether the target data is the date update information, or data of the full data backup or difference data from the preceding day (hereinafter, referred to backup history information).

In addition, when the backup software does not operate normally, confirmation of the backup history information of each magnetic tape cartridge has been entirely impossible when, for example, power of a computer or user interface is in discontinuity, or in trouble, or in maintenances.

It is, therefore, an object of the present invention to provide a data backup system which can easily confirm backup history information of a data backup storage medium regardless of an operating environment of backup software, while eliminating the aforementioned issues.

### SUMMARY OF THE INVENTION

According to a first aspect of the present invention, there is provided a data backup system which includes a storage medium cartridge for storing target data; an auxiliary storage medium mounted on the storage medium cartridge; data backup means for backing up the target data in the storage medium cartridge; and history information writing means for writing backup history information containing at least information of updated date of the backup history information in the auxiliary storage medium with different means from the data backup means, wherein the history information writing means writes the backup history information in the auxiliary storage medium after the data backup means backs up the target data in the storage medium cartridge.

In the first aspect of the present invention, the history information writing means writes the backup history information in the auxiliary storage medium after the data backup means backs up the target data in the storage medium cartridge by using a different method from the data backup means. Through this, since the backup history information containing at least information of updated date of the backup history information can be read by the different method from that of target data which is backed up in the storage medium, the backup history information can be easily confirmed regardless of an operating environment of the backup software.

According to a second aspect of the present invention, there is provided a data backup system according to the first aspect, in which the auxiliary storage medium is an RFID (Radio Frequency IDentification) tag where the backup history information is written by an RFID tag writer of the history information writing means.

In the second aspect of the present invention, the RFID tag writer of the history information writing means writes the backup history information in the RFID tag after the data backup means backs up the target data in the storage medium cartridge. Through this, since the backup history information containing at least information of updated date of the backup history information can be read from the RFID tag, the backup history information can be easily confirmed regardless of operating environment of backup software.

According to a third aspect of the present invention, there is provided a data backup system according to the first aspect, in which the auxiliary storage medium is a barcode label where a barcode of the backup history information is written by a barcode writer of the history information writing means.

In the third aspect of the present invention, the barcode writer of the history information writing means writes a barcode of the backup history information in the barcode label after the data backup means backs up the target data. Through this, since the backup history information containing at least information of updated date of the backup history information can be read by a barcode reader, the backup history information can be easily confirmed regardless of operating environment of the backup software.

Meanwhile the barcode includes a one-dimensional barcode and a two-dimensional barcode (two-dimensional code).

According to a fourth aspect of the present invention according to any one of aspects of the first to third, there is provided a data backup system in which the backup history information contains identification information of full data backup or diferrence data backup.

In the fourth aspect of the present invention, the target data stored in the storage medium cartridge can be easily confirmed whether the target data is fully backed up data or difference data from the preceding day.

According to the present invention, the backup history information of a data backup storage medium can be easily confirmed regardless of an operating environment of backup software. Therefore, when intended data is restored, the data backup storage medium in which the intended data was backed up can be easily identified without referring to the backup software.

### BRIEF DESCRIPTION OF THE DRAWINGS

FIG. 1 is an illustration showing a configuration of a data backup system according to an embodiment of the present invention;

FIG. 2 is an illustration showing a functional configuration of a backup system of the embodiment;

FIG. 3 is an illustration showing example of cartridge information of the embodiment;

FIG. 4 is a flowchart showing a backup processing procedure of the embodiment;

FIG. 5 is a perspective view showing a usage state of a magnetic tape cartridge and reader of the embodiment.

### DETAILED DESCRIPTION OF THE PREFERRED EMBODIMENT

### Embodiment

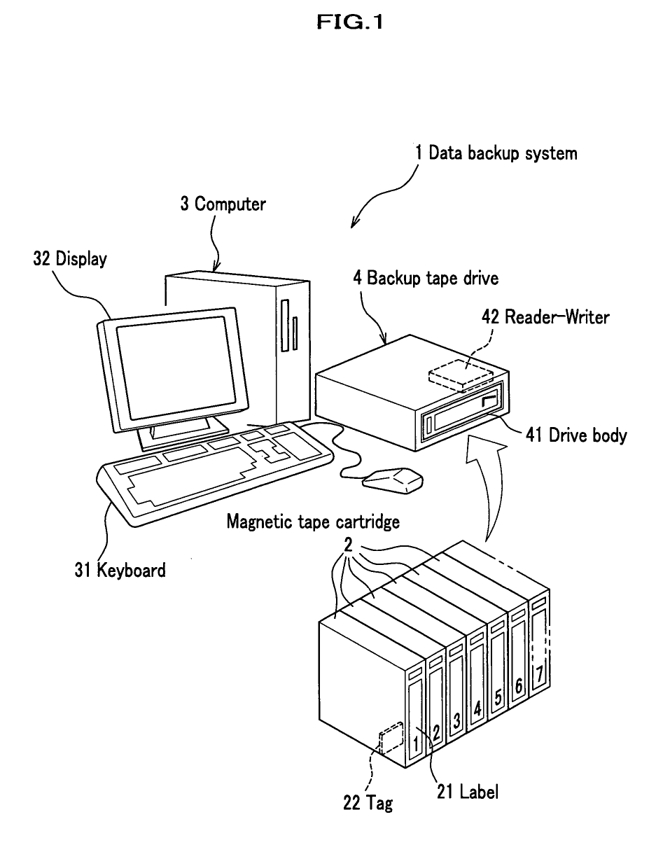

Next, an embodiment of the present invention will be explained in detail by referring to figures, as needed. FIG. 1 is an illustration showing a configuration of a data backup system according to the embodiment of the present invention. In the embodiment, a magnetic tape cartridge is assumed to be a storage medium cartridge for data backup. However, the storage medium cartridge according to the present invention is not limited thereto.

As shown in FIG. 1, a data backup system 1 according to the embodiment is a system for backing up target data in a magnetic tape cartridge 2, and configured by connecting a backup tape drive 4 (data backup means) to a computer 3 of a file server.

The magnetic tape cartridge 2 is external storage medium for backing up data, and provided with a plurality of magnetic tape cartridges specific to each day of the week. On a label 21 of each magnetic tape cartridge 2, for example, one of identification numbers from 1 to 7 is printed. Therefore, an operator can check a magnetic tape cartridge specific to a day of the week with eyes from the identification number, by assuming that the magnetic tape cartridge with the identification number “1” is, for example, specific to Monday. The operator implements full backup of data once a week on a predetermined day (for example, on Sunday) of the week, and on other days of the full backup, difference data from the preceding day is backed up in the magnetic tape cartridge specific to each day of the week. In the magnetic tape cartridge 2, a tag 22 (RFID tag: Radio Frequency IDentification tag) is arranged on an internal surface of a side wall on which the label 21 is pasted. Meanwhile, although the tag 22 is arranged within the magnetic tape cartridge 2 in the embodiment, the present invention is not limited to this manner. The tag 22 may be pasted on an external surface of a case of the magnetic tape cartridge 2.

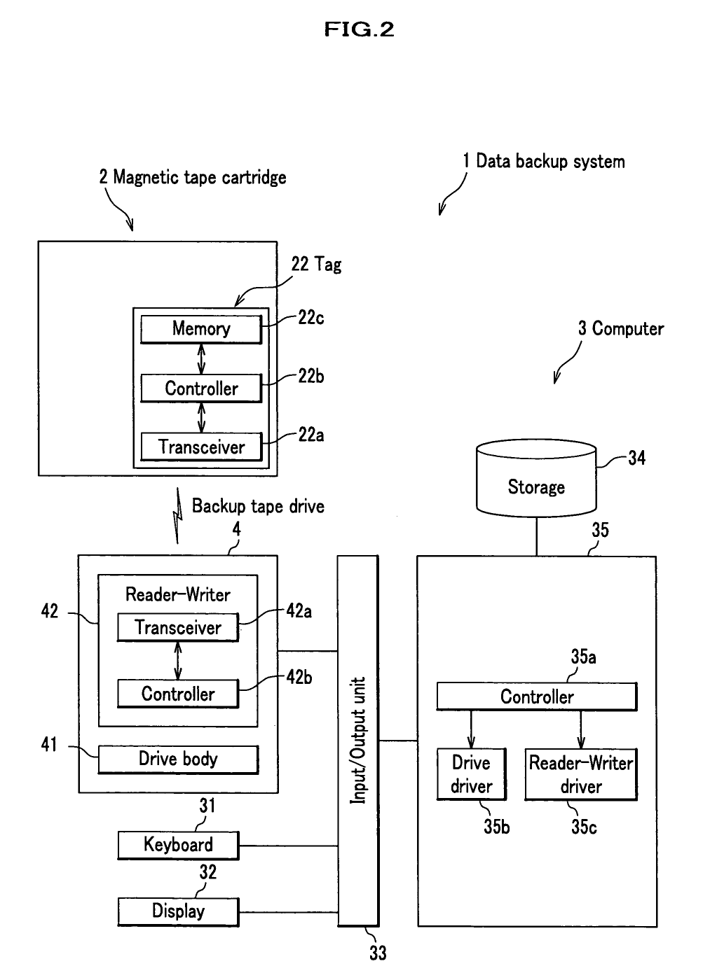

FIG. 2 is an illustration showing a functional configuration of a data backup system.

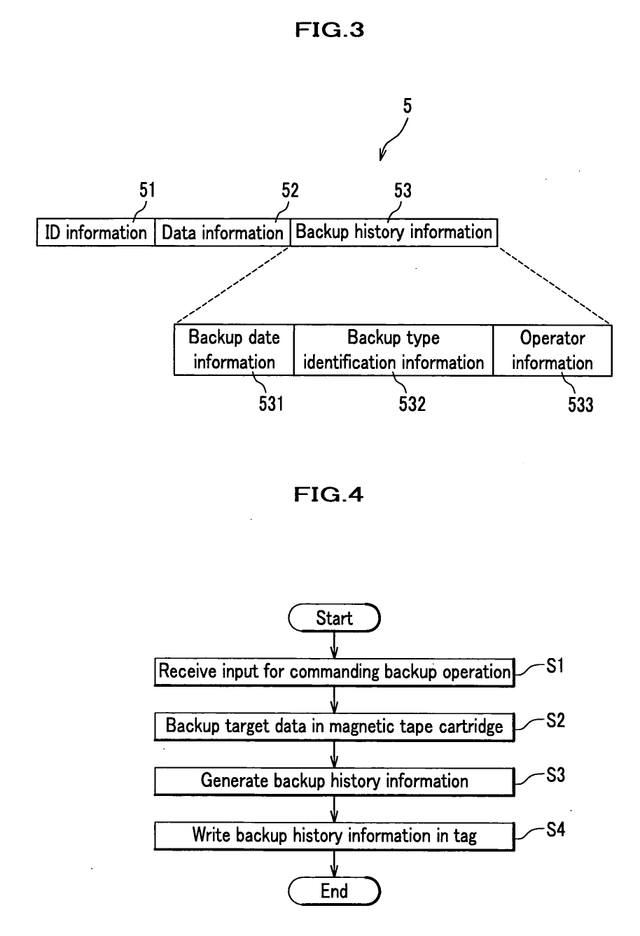

As shown in FIG. 2, the tag 22 includes a transceiver 22a, a controller 22b, and a memory 22c. The tag 22 is configured to be capable of wireless communication with a reader-writer 42, which will be described later. The transceiver 22a is a coiled antenna, and connected to the controller 22b and the memory 22c. Cartridge information 5 (refer to FIG. 3) of the magnetic tape cartridge 2 is stored in the memory 22c of the tag 22.

Here, as shown in FIG. 3, the cartridge information 5 is composed of ID information 51, data information 52, and backup history information 53. The ID information 51 is identification information unique to the magnetic tape cartridge 2. The data information 52 is a content of data, for example, data such as shared file data of the computer 3, stored in the magnetic tape cartridge 2. The backup history information 53 is composed of information of date and time of data update (date update information) 531, full or difference data identification information (backup type identification information) 532, and operator information 533, and updated at every backup operation. The date update information 531 is data indicating date and time of backing up the target data in the magnetic tape cartridge 2. The full or difference data identification information (backup type identification information) 532 is identification information indicating that backed up target data is fully backed up data or difference data from the preceding day. The operator information 533 is identification information indicating an operator in charge of the backup operation. Meanwhile, when a content of backup data is changed for a given magnetic tape cartridge 2, the data information 52 may be updated at every backup operation by putting the data information 52 into the backup history information 53.

The computer 3 shown in FIG. 2 is, for example, a server for sharing a file which runs on a computer network such as LAN (Local Area Network) which connects a plurality of terminals (not shown), and capable of collective management of data of the shared file. The computer 3 includes a keyboard 31, a display 32, an input/output unit 33, a storage 34, and a CPU 35.

The keyboard 31 is an operating unit for inputting various kinds of information in the CPU 35 through the input/output unit 33, and used for inputting the various kinds of information by the operator and for managing date of a file. The display 32 displays information output from the CPU 35 via the input/output unit, and displays, for example, the backup history information. The storage 34 is configured with a RAM (Random Access Memory) used for, for example, processing of the CPU 35 described later, a ROM (Read Only Memory) for storing various kinds of information, and an external storage unit such as a hard disk. The storage 34 stores target data to be backed up, for example, the shared file, as well as storing various kinds of programs such as drivers for driving backup software and a reader-writer for achieving a backup function.

The CPU 35 reads out data and programs from the storage 34, controls various kinds of unit such as the display 32 and tape drive 4, which will be described later, for the backup, and is configured typically with a controller 35a, a drive driver 35b, and a reader-writer driver 35c.

The controller 35a reads out programs from the storage 34 based on an input by an operator through the keyboard 31, and controls a drive body 41 and driving of a reader-writer 42 of the backup tape drive 4 through the drive driver 35b and the reader-writer driver 35c. Here, the controller 35a automatically generates the backup history information 53 (refer to FIG. 3) when the controller 35a controls and drives the drive driver 35b, and also controls and drives the reader-writer 42 so that the backup history information 53 is written in the tag 22. Meanwhile, the controller 35a automatically introduces the date update information 531 of the backup history information 53, and generates the backup type identification information 532 and operator information 533 based on an input through the keyboard 31 when the backup operation starts.

The drive driver 35b transmits a drive driving signal to the backup tape drive 4 by a command from the controller 35a. In addition, similar to this, the reader-writer driver 35c transmits a reader-writer driving signal to the backup tape drive 4 by a command from the controller 35a.

The backup tape drive 4 is connected to the computer 3 via the input/output unit 33, and configured with the drive body 41 and the reader-writer 42.

The drive body 41 is formed so that the magnetic tape cartridge 2 can be inserted therein (refer to FIG. 1), and backs up target data stored in the storage 34 into the magnetic tape cartridge 2 by the drive driving signal from the drive driver 35b. Here, the target data is data of shared file of the computer 3.

The reader-writer 42 includes a transceiver 42a and a controller 42b, and is arranged so that the transceiver 42a faces the transceiver 22a of the tag 22 of the magnetic tape cartridge 2 when the magnetic tape cartridge 2 is inserted in the drive body 41 of the backup tape drive 4. The reader-writer 42 communicates with the transceiver 22a of the tag 22 via the transceiver 42a by receiving a command from the controller 35a of the computer 3, by using the controller 42b. As a result, the reader-writer 42 can write and read information stored in the memory 22c of the tag 22 without contact.

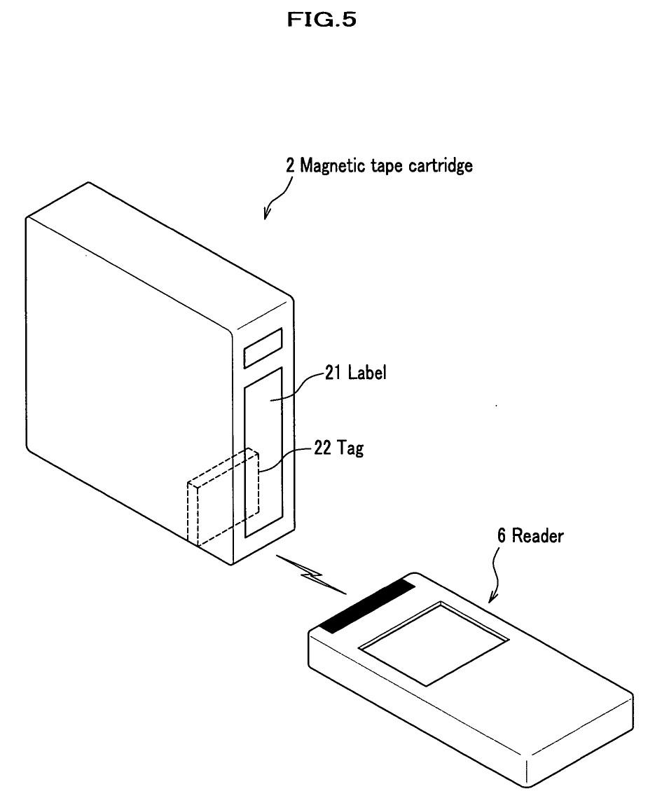

Next, a backup operation procedure of the data backup system 1 according to the embodiment will be explained by referring to FIG. 4 (FIG. 2, as needed). FIG. 4 is a flowchart showing the backup operation procedure. FIG. 5 is a perspective view showing a usage state of a magnetic tape cartridge and a reader.

First, after setting a magnetic tape cartridge 2 specific to a day of the week in the backup tape drive 4, the computer 3 receives an input commanding the backup operation (Step S1), as shown in FIG. 4. The input is implemented by an operator through the keyboard 31, and includes information whether the command is for the full data backup or difference data backup.

Next, the controller 35a of the CPU 35 drives and controls the drive body 41 of the backup tape drive 4 based on an input command, and backs up target data into the magnetic tape cartridge 2 (Step S2). Meanwhile, the backup operation procedure here is an execution procedure by a program of backup software stored in the storage 34, and implemented by the controller 35a by reading out the program from the storage 34. The target data is a shared file stored in the storage 34.

When backup of the target data is completed, the controller 35a automatically generates the backup history information 53 (refer to FIG. 3) (Step S3). Then, the controller 35a writes the backup history information 53 in the tag 22 by driving and controlling the reader-writer 42 of the backup tape drive 4 (Step S4). With the above, a series of the operations is completed. Meanwhile, a writing procedure in the tag here is an execution procedure by a program stored in the storage 34, and implemented by the controller 35a by reading out the program from the storage 34, as needed. In the program, a writing operation in the tag 22 is executed, triggered by completion of the backup operation by the backup software.

Like the above, in the magnetic tape cartridge 2 on which the tag 22, of which backup history information 53 is updated, is mounted, the backup history information 53 can be easily read out as shown in FIG. 5, by using a reader 6 which is capable of communicating with the tag 22. Meanwhile, the backup history information 53 may be directly displayed on a display disposed on the reader 6, or may be displayed on another display in another terminal by transferring the information from the reader 6 to another terminal. In addition, another terminal may be configured to be able to manage data such as transferred backup history information 53.

According to the above, the following advantages are obtained in the embodiment.

According to the data backup system 1 of the present embodiment, the reader-writer 42 of the backup tape drive 4 writes the backup history information 53 in the tag 22 after the drive body 41 backs up the target data in the magnetic tape cartridge 2. With the above procedure, since the backup history information 53 containing the date update information 531 and backup type identification information 532 can be read by the reader 6 which is capable of communication with the tag 22, the backup history information 53 can be easily confirmed regardless of operating environment of the backup software.

Accordingly, since the date update information 531 and backup type identification information 532 of the backup history information 53 can be easily confirmed, the target data can be easily and certainly identified at a data recovery work, thereby resulting in improvement of efficiency and certainty of the data recovery work.

In addition, in the data backup system 1 according to the embodiment, since the controller 35a commands writing of the backup history information 53 and the reader-writer 42 writes the backup history information 53 in the tag 22, a manual operation is unnecessary, thereby resulting in prevention of a human error.

Meanwhile, according to the data backup system 1 of the present embodiment, the data backup system 1 also has advantages when it is applied to a library apparatus, where a magnetic tape cartridge 2 can be selectively picked up from a magazine storing a plurality of magnetic tape cartridges 2, and can be inserted in a streaming tape drive. That is, by disposing the reader 6 in a robot hand which picks up (or inserts) the magnetic tape cartridge 2 from (or to) the magazine, the backup history information 53 of the magnetic tape cartridge 2 can be easily read out when the cartridge 2 is picked up, thereby resulting in certain selection of an intended magnetic tape cartridge 2.

The data backup system 1 according to the embodiment has been explained in the above. However, the present invention is not limited thereto, and can be applied to various forms.

In the embodiment, the tag 22 is used as a medium for storing the backup history information 53. However, the present invention is not limited thereto, and a barcode may be used for this purpose. For example, the data backup system may be configured so that a two-dimensional barcode indicating the backup history information 53 (refer to FIG. 3) is printed on a barcode label (a barcode label pasted in advance on the magnetic tape cartridge 2) after backing up target data in the magnetic tape cartridge 2. Here, the barcode label may include a label 21 of the magnetic tape cartridge 2. According to this kind of system, a system, where the backup history information 53 can be easily read by a barcode reader-writer, can be provided. Meanwhile, the backup history information 53 may be expressed with a one-dimensional barcode. In addition, the barcode label may be prepared, separated from the magnetic tape cartridge 2, and may be pasted on the magnetic tape cartridge 2 after printing the barcode.

In the embodiment, the data backup system has been configured so that the backup history information 53 is automatically generated and written in the tag 22. However, the system is not limited thereto. The backup history information 53 may be generated by an operator through keyboard entry, and may be written in the tag 22 (or the barcode label). In this case, an alarm may be displayed on the display 32 if a series of the operations is completed without correctly writing the backup history information 53 in the tag 22 (or the barcode label).

In the embodiment, the data backup system has been configured so that the reader-writer 42 is arranged within the backup tape drive 4. However, the system is not limited thereto. The reader-writer 42 may be an external unit of the backup tape drive 4. According to this, maintenance of the reader-writer 42 becomes easier.

In the embodiment, a shared file of the computer 3 as a server has been exemplified as target data. However, the present invention is not limited thereto. Any data to be backed up may be the target data. In addition, in the embodiment, the backup operation has been implemented by fixing each magnetic tape cartridge 2 on a day specific to a day of the week. However, the present invention is not limited thereto. A method of the backup operation may be designed arbitrarily, as needed.

In the embodiment, the date update information 531, the backup type identification information 532, and the operator information have been picked up as the backup history information 53. However, any information containing the date update information 531 may be used in the present invention. For example, any information containing such as a chief administrator of the backup operation, and a number of the magnetic tape cartridge 2 managed by a machine, may be used.

The cartridge information 5 to be written in the tag 22 may be configured to generate a target ID, to code the target ID using a key for generating the target ID, and to write a coded target ID in the tag 22. With this method, falsification of the cartridge information 5 by a third party can be prevented.

What is claimed is:

1. A data backup system, comprising:
a storage medium cartridge for storing target data;
an auxiliary storage medium mounted on the storage medium cartridge;
data backup means for backing up the target data in the storage medium cartridge; and
history information writing means for writing backup history information containing at least information of updated date of the backup history information in the auxiliary storage medium with different means from the data backup means,
wherein the history information writing means writes the backup history information in the auxiliary storage medium after the data backup means backs up the target data in the storage medium cartridge.

2. The data backup system according to claim 1,
wherein the backup history information contains identification information of full data backup or difference data backup.

3. The data backup system according to claim 1,
wherein the auxiliary storage medium is an RFID (Radio Frequency IDentification) tag where the backup history information is written by an RFID tag writer of the history information writing means.

4. The data backup system according to claim 3,
wherein the backup history information contains identification information of full data backup or difference data backup.

5. The data backup system according to claim 1,
wherein the auxiliary storage medium is a barcode label where a barcode of the backup history information is written by a barcode writer of the history information writing means.

6. The data backup system according to claim 5,
wherein the backup history information contains identification information of full data backup or difference data backup.

7. The data backup system according to claim 5,
wherein the barcode label is pasted on the storage medium cartridge in advance, and a barcode is printed on the barcode label.

8. The data backup system according to claim 5,
wherein the barcode label is prepared separate from the storage medium cartridge, and pasted on the storage medium cartridge after printing a barcode.

9. The data backup system according to claim 5,
wherein the barcode label is a one-dimensional barcode.

10. The data backup system according to claim 5,
wherein the barcode label is a two-dimensional barcode.

11. The data backup system according to claim 1,
wherein the storage medium cartridge is a magnetic tape cartridge.

12. The data backup system according to claim 11,
wherein the auxiliary storage medium is an RFID tag where the backup history information is written by an RFID tag writer of the history information writing means.

13. The data backup system according to claim 12,
wherein the RFID tag is arranged within the magnetic tape cartridge.

14. The data backup system according to claim 12,
wherein the RFID tag is pasted on an external surface of the magnetic tape cartridge.
